(19) United States
(12) Patent Application Publication
(10) Pub. No.: US 2008/0034848 A1
(43) Pub. Date: Feb. 14, 2008

(54) Method and Apparatus for Monitoring Biofilm Formation

(76) Inventors: Thomas Eugene Cloete, Pretoria (ZA); Stefanus Johannes Van Vuuren, Pretoria (ZA)

Correspondence Address: KNOBBE MARTENS OLSON & BEAR LLP, 2040 MAIN STREET, FOURTEENTH FLOOR, IRVINE, CA, 92614, US

(21) Appl. No.: 10/581,512

(22) PCT Filed: Dec. 3, 2004
(86) PCT No.: PCT/IB04/52653

§ 371 Date: Mar. 16, 2007

(30) Foreign Application Priority Data
Dec. 5, 2003 (ZA) 2003/9462

(51) Int. Cl. G01N 17/00; G01N 21/00

(52) U.S. Cl. 73/61.48; 422/73

(57) ABSTRACT

This invention relates to an apparatus (10) for monitoring biofilm formation on a surface (12). The apparatus (10) comprises a disk-shaped member (14) which provides said surface (12); and a sensor (16) for measuring biofilm formation on a measuring zone (18) of the surface (12). A plurality of bodies (29) are mounted on the surface (12) of the disk-shaped member (14) so that biofilm formation on different materials can be observed. The apparatus (10) includes a housing (22) wherein the member (14) is located. A body of liquid (24), such as water, is disposed inside the housing (22) and fills the housing (22) only partly. The member (14) is continuously moved into and out of the liquid (24) by being rotated about its central axis (30).

### INTRODUCTION

This invention relates to a method and apparatus for monitoring biofilm formation.

### BACKGROUND TO THE INVENTION

In this specification, the term “biofilm” means microorganisms accumulated or formed on a surface. The impact of biofilm formation varies in different technical systems, thus, they can tolerate biofilms to a lesser or greater extent until an interference of process or product quality is observed. In order to keep biofilm growth below a certain “threshold of interference”, it is necessary to obtain information about the actual extent of biofilm formation for timely and effective countermeasures. Such a “threshold of interference” varies according to the demands of a given process. Known monitoring devices for monitoring biofilm formation on surfaces include fibre optic devices and infrared monitors. (Melo, L. F., Flemming, H-C., Cloete, T. E (2003), IWA Publishing. “Water Science & Technology, Biofilm Monitoring” pp1-8, 19-24, 39-43.)

A known fibre optic device consists of a sending fibre and a receiving fibre, both penetrating a wall of a water pipe with the tips of the fibres even to the inner pipe surface. By using the intensity of backscattered light for assessing the thickness of the deposit, which has accumulated on the tip of the fibre, biofilm formation on the tips of the fibres is detected. The receiving fibre collects the signal and forwards it to a detection and quantification unit. A disadvantage of this device is that, since the tips of the optical fibres are relatively very small, there is only a small surface on which biofilm accumulates. The measurements taken are therefore not representative of biofilm formation in a complete system.

A known infrared monitor used for detecting biofilm formation on a surface in a flowing system, includes a pipe through which water flows. The pipe has transparent glass walls, which provide the surface for biofilm accumulation. An infrared transmitter is located on one side of the pipe and an infrared receiver is located on an opposite side. Radiation from the transmitter to the receiver passes through both glass walls of the pipe; the biofilm accumulated on the glass surface; and the water passing through the pipe. The difference between the radiation emitted and that received is the amount absorbed by the system. The amount of infrared radiation absorbed by the biofilm is proportional to the amount of biofilm present on the surface.

A disadvantage of this system is that the difference between the radiation emitted and that received is the amount of radiation absorbed by the system and not only radiation absorbed by the biofilm formed on the surface. Thus, as properties of the water varies, the amount of radiation absorbed by the water also varies and therefore does not produce accurate results regarding the amount of biofilm formation.

U.S. Pat. No. 5,155,555 discloses a method and apparatus for measuring biofilm formation in an opaque process stream. A section of a disk is immersed into the fluid stream and remains in the stream for a predetermined amount of time to allow biofilm to accumulate on the surface of the disk. After the predetermined amount of time, the disk is rotated to a position so that the previously immersed section is exposed for optical monitoring. The monitoring takes place by casting a light beam of known intensity i onto the biofilm formed on the disk and measuring the intensity i′ of the light reflected from the disk. The two intensities i and i′ are then compared and the ration is a measure of film thickness.

A disadvantage of the above method and apparatus for measuring biofilm formation is that since the disk remains in the stream for a predetermined amount of time and is then removed from the stream to take the measurements, the measurements are relatively inaccurate. By retaining the disk in a static position in the stream during formation of biofilm on the surface of the disk and thereafter moving the disk out of the stream, some of the biofilm may fall off from the disk or it may not form uniformly, thus not providing accurate measurements.

A second disadvantage is that the measurements are not taken continuously but at predetermined intermittent times and the apparatus therefore does not provide real time measurement of biofilm formation to allow continuous control over biofilm formation. It is known that it is relatively more effective to prevent the formation of biofilm, or to remove such biofilm shortly after the formation thereof, than to remove the biofilm after a period of growth, as the biofilm develops a protective layer which is resistant to biocides.

### OBJECT OF THE INVENTION

It is therefore an object of the present invention to provide a method and apparatus for monitoring biofilm formation with which the aforesaid disadvantages can be overcome or at least minimised.

### SUMMARY OF THE INVENTION

According to a first aspect of the invention there is provided apparatus for monitoring biofilm formation on a surface comprising:
a member providing said surface for continuously moving into and out of a body of liquid; and
a sensor for continuously measuring biofilm formation and for being located outside the body of liquid and for measuring biofilm formation on a measuring zone of the surface when disposed outside the body of liquid.

The member may be a disk disposed inside a housing and rotatable about an axis.

The housing may be provided with a liquid inlet and a liquid outlet and a passage for the liquid extending through the housing from the inlet to the outlet, with at least a portion of the disk being disposed inside the passage.

The liquid may fill the housing only partly, the arrangement being such that as the member continuously rotates in the housing, at any given time a portion thereof is submerged in the liquid and another portion, providing the said measuring zone, is disposed outside the liquid.

Further according to the invention, a plurality of vanes are mounted along the outer periphery of the disk and may extend from the disk to aid rotation of the disk about its central axis, whilst the liquid flows from the inlet to the outlet along the passage.

The sensor may be disposed inside the housing above the level of the liquid, in use.

The sensor may include a transmitter for transmitting a light beam onto said measuring zone and a receiver for receiving light reflected from the surface.

Alternatively, the disk may be transparent and the transmitter and the receiver may be located on opposite sides of the disk, the arrangement being such that the transmitter transmits a light beam onto said measuring zone and the receiver receives the light passing through the surface.

Further according to the invention, a plurality of bodies of different material are mounted on the disk in the measuring zone for observing biofilm formation on different materials.

According to a second aspect of the invention there is provided a method for monitoring biofilm formation on a surface including the steps of:
providing a body of liquid;
providing a member having a surface for biofilm formation including a measuring zone and for being disposed outside the body of liquid;
continuously moving the surface into and out of the body of liquid;
providing a sensor for measuring biofilm formation outside the body of liquid; and
continuously measuring biofilm formation by measuring light being received from the said measuring zone.

The step of continuously moving the surface into and out of the body of liquid may include the step of rotating the member about a central axis, the arrangement being such that a portion thereof is submerged in the liquid and another portion is outside the liquid.

The method may include the further step of observing biofilm formation on different types of materials.

The step of observing biofilm formation on different types of materials may include the steps of providing bodies of different types of materials, mounting the bodies on the member in the measuring zone so that they are rotated with the member and observing said biofilm accumulation thereon

### BRIEF DESCRIPTION OF THE DRAWINGS

The invention will now be described further by way of a non-limiting example with reference to the accompanying drawings wherein:

FIG. 1 is a perspective view of an apparatus according to a preferred embodiment of the invention for monitoring biofilm formation, with a housing being open to show a member providing a surface on which the biofilm forms; and

FIG. 2 is the same as FIG. 1 with the housing closed and showing a sensor for monitoring the biofilm formation on the surface.

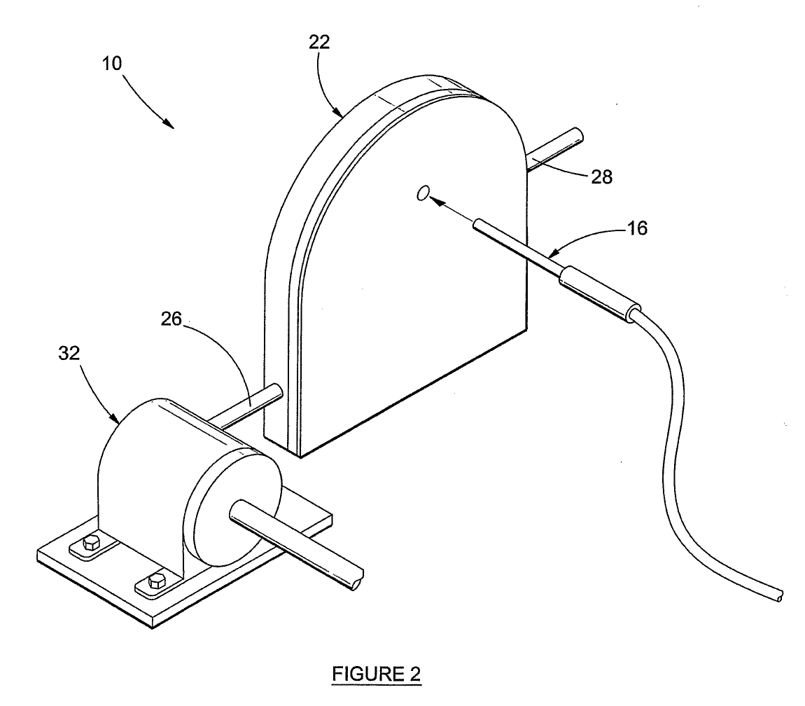

### DESCRIPTION OF A PREFERRED EMBODIMENT OF THE INVENTION

Referring to the drawings, an apparatus for monitoring biofilm formation according to a preferred embodiment of the invention is generally designated by reference numeral 10.

The apparatus 10 for monitoring biofilm formation on a surface 12 comprises a disk-shaped member 14 which provides said surface 12; and a sensor 16 for measuring biofilm formation on a measuring zone 18 of the surface 12.

A plurality of vanes 20, are mounted along and extend from the outer periphery of the disk-shaped member 14.

The apparatus 10 includes a housing 22 wherein the member 14 is located. A body of liquid 24, such as water, is disposed inside the housing 22 and fills the housing 22 only partly. The housing 22 has a liquid inlet 26 and a liquid outlet 28 and a passage for the liquid extending through the housing 22 from the inlet 26 to the outlet 28. The apparatus further includes bodies 29 of different material mounted on the member 14 in the measuring zone 18 so that they are rotated with the member. The bodies 29 make it possible to observe biofilm formation on different materials.

In use, the member 14 is continuously moved into and out of the liquid 24 by being rotated about its central axis 30. At any given time, a portion of the member 14 is therefore submerged in the liquid 24 and another portion, providing the said measuring zone 18, is disposed outside the liquid 24.

Rotation of the member 14 is further facilitated by a water pump 32, which pumps the liquid 24 into the housing 22; and the vanes 20 extending from the member 14 aiding in propulsion thereof whilst the liquid 24 flows from the inlet 26 to the outlet 28 along the passage.

The sensor 16 is located inside the housing 22 above the level of the liquid 24. The sensor 16 includes a transmitter and a receiver (both not shown). The transmitter transmits green light onto the surface 12 as it was found that the most accurate results were obtained when using green light, in comparison with light of other wavelengths that were tested.

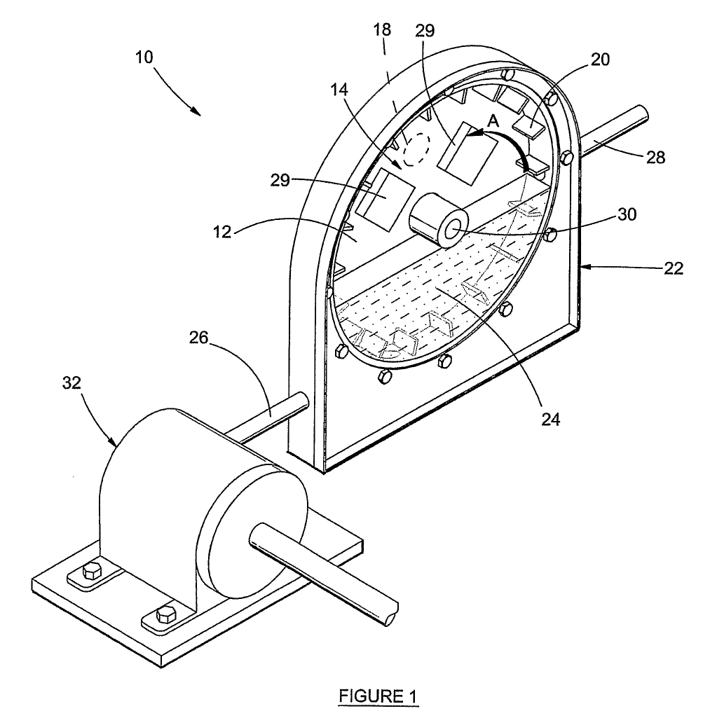

Further in use, as liquid 24 is pumped into the housing 22 via the inlet 26, through the passage and out of the housing 22 via the outlet 28, the member 14 is rotated about its central axis 30 as shown by arrow A in FIG. 1. Rotation of the member 14 continuously moves the member 14 into and out of the liquid 24, the arrangement being such that biofilm formation on the surface 12 can be measured at the measuring zone 18. The transmitter transmits a green light beam onto said measuring zone 18 and the receiver receives the beam of light being reflected from the surface 12. The sensor 16 sends a signal, which represents the amount of reflected light to a processor (not shown) for determining the amount of biofilm formation on the surface 12, the amount of reflected light being proportional to the amount of biofilm formed on the surface 12. Biofilm also forms on the bodies 29 of different material. Biofilm accumulation on different materials can therefore also be observed.

It will be appreciated that the apparatus 10 provides real time monitoring of biofilm formation on the surface 12 since the member 14 continuously rotates into and out of the liquid 24. It will further be appreciated that biofilm formation on different materials can be observed by using bodies 29 of different materials and intermittently removing said bodies 29 to monitor biofilm accumulation thereon. The apparatus 10 can be connected to an existing system and as the liquid 24 continuously passes through the apparatus 10, accurate measurements of biofilm formation, representing the entire system, is obtained. The apparatus 10 according to the invention could therefore provide an output signal to a biocide dosing means (not shown) for applying an effective amount of biocide to the water 24 as soon as measurements indicate that biofilm has formed on the surface 12.

It will also be appreciated that variations in detail are possible with a method and apparatus for monitoring biofilm formation according to the invention without departing from the scope of this disclosure. For example, the disk may be transparent and the transmitter and the receiver may be located on opposite sides of the disk, the arrangement being such that the transmitter transmits a light beam onto said measuring zone and the receiver receives the light passing through the surface. The received light is proportional to the amount of biofilm formed on the surface. Further for example, the side walls of the housing 20 could be either transparent or opaque to measure the formation of different types of microorganisms.

1. Apparatus for monitoring biofilm formation on a surface comprising:
a member providing said surface for continuously moving into and out of a body of liquid; and
a sensor for continuously measuring biofilm formation and for being located outside the body of liquid and for measuring biofilm formation on a measuring zone of the surface when disposed outside the body of liquid.

2. Apparatus according to claim 1 wherein the member is a disk disposed inside a housing and rotatable about an axis, and wherein the housing is provided with a liquid inlet and a liquid outlet and a passage for the liquid extending through the housing from the inlet to the outlet, with at least a portion of the disk being disposed inside the passage, and wherein the liquid fills the housing only partly, the arrangement being such that as the member continuously rotates in the housing, at any given time a portion thereof is submerged in the liquid and another portion, providing the said measuring zone, is disposed outside the liquid.

3. Apparatus according to claim 2 including a plurality of vanes mounted along the outer periphery of the disk and which extend from the disk to aid rotation of the disk about its central axis, whilst the liquid flows from the inlet to the outlet along the passage.

4. Apparatus according to claim 2 or claim 3 wherein the sensor is disposed inside the housing above the level of the liquid, in use.

5. Apparatus according to claim 1 wherein the sensor includes a transmitter for transmitting a light beam onto said measuring zone and a receiver for receiving light reflected from the surface.

6. Apparatus according to any one of claims 1 to 4 wherein the disk is transparent and the transmitter and the receiver are located on opposite sides of the disk, the arrangement being such that the transmitter transmits a light bean onto said measuring zone and the receiver receives the light passing through the surface.

7. Apparatus according to any one of claims 2 to 6 wherein a plurality of bodies of different material are mounted on the disk in the measuring zone for observing biofilm formation on different materials.

8. A method for monitoring biofilm formation on a surface including the steps of:
providing a body of liquid;
providing a member including a surface having a measuring zone and for being disposed outside the body of liquid;
continuously moving the surface into and out of the body of liquid;
providing a sensor for measuring biofilm formation outside the body of liquid; and
continuously measuring biofilm formation by measuring light being received from the said measuring zone.

9. A method for monitoring biofilm formation according to claim 8 wherein the step of continuously moving the surface into and out of the body of liquid includes the step of rotating the member about a central axis, the arrangement being such that a portion thereof is submerged in the liquid and another portion is outside the liquid.

10. A method for monitoring biofilm formation according to claims 8 or 9 which includes the further step of observing biofilm formation on different types of materials.

11. A method for monitoring biofilm formation according to claim 10 wherein the step of observing biofilm formation on different types of materials includes the steps of providing bodies of different types of materials, mounting the bodies on the member in the measuring zone so that they are rotated with the member and observing said biofilm accumulation thereon.

12. (canceled)

13. (canceled)
